(19) United States
(12) Patent Application Publication
(10) Pub. No.: US 2003/0055785 A1
(43) Pub. Date: Mar. 20, 2003

(54) System and method for electronic wallet transactions

(75) Inventor: Sandip Lahiri, Tampa, FL (US)

Correspondence Address: Joseph T. Van Leeuwen, P.O. Box 81641, Austin, TX, 78708-1641, US

(73) Assignee: International Business Machines Corporation, Armonk, NY

(21) Appl. No.: 09/956,761

(22) Filed: Sep. 20, 2001

(51) Int. Cl. G06F 17/60

(52) U.S. Cl. 705/41

(57) ABSTRACT

A system and method for an electronic wallet transaction device is presented. A user enters his account information into an e-wallet. The e-wallet encrypts the account information and receives a password, a spending limit, and a merchandise type that is authorized for purchase. The e-wallet is ready for purchase transactions. The user selects merchandise and takes it to an electronic checkout system. The electronic checkout system scans the merchandise and prompts the e-wallet for authorization to purchase the merchandise. The e-wallet determines if the merchandise is authorized for purchase and if the cost of the merchandise is allowed, and prompts the user for a password. The user enters a password and the e-wallet sends the account information to the electronic checkout system. The electronic checkout system receives the account information and completes the merchandise transaction. The e-wallet may also be used to configure other remote e-wallets.

### BACKGROUND OF THE INVENTION

1. Technical Field

The present invention relates in general to a method and system for electronic transactions. More particularly, the present invention relates to a system and method for enabling wireless transactions using existing electronic commerce infrastructures.

2. Description of the Related Art

Ways in which consumers purchase merchandise are increasing due to technological innovations. For example, the Internet has spawned electronic commerce purchasing with consumers. As consumers become more comfortable with the security of buying merchandise over the Internet, electronic commerce sales may continually increase. The consumers' increased comfort in purchasing merchandise electronically increases the use of wireless purchasing technology. For example, Mobil's Speedpass™ gasoline purchasing system uses wireless technology that allows a user to waive a card across an area on a gasoline pump to purchase gasoline. Another example of a wireless transaction is the EZ-Pass toll road system that is used in various parts of the United States. A user has a device in his car that transmits transaction information to a receiving device as the user drives through an EZ-Pass tollbooth.

Transaction executions are quicker and more convenient in both of the examples described above due to wireless technology. A challenge found with existing wireless systems is that they are considered a “closed community” approach. In a closed community approach, the buyer, the seller, and the billing authority form a binding agreement to exchange value for goods or services within their community. A wireless device that is intended for purchasing a specific type of merchandise may not be used to purchase other types of merchandise.

Another approach is an “open community” approach. An open community approach allows a widespread acceptance of a payment method. Open community approaches are convenient for users because users can trust that their payment method will be accepted from most merchants. For example, credit cards are a form of an open community approach. Even though credit cards are not accepted everywhere, they are accepted at a large percentage of merchant stores, regardless of what the merchant sells. Open community approaches are the result of risk sharing agreements between a bank and many merchants. They typically have a widely recognized brand, such as Visa™, which reassures users and merchants.

A challenge found with developing an open community approaches is that they require extensive infrastructure, which is expensive and complex. In order to develop a wireless open community system, extensive infrastructure costs are incurred. Similar risk sharing agreements as described above are also required, along with a way of verifying the user and authenticating the electronic payment device. What is needed, therefore, is a way to provide an open community wireless system that has minimal infrastructure cost.

### SUMMARY

It has been discovered that by using a wireless device in conjunction with an open community approach, the combination performs as an open community wireless system. The wireless device may be used to purchase merchandise and may also be configured to limit the type of merchandise being purchased along with limiting the total amount of merchandise purchased. The wireless device may also configure a secondary wireless device for restricted or unrestricted purchases.

A user configures an e-wallet device by providing account information to the e-wallet. A credit card, debit card, or other financial currency exchange method may be entered into the e-wallet. The e-wallet encrypts the account information and prompts the user for a password. The user enters a password and the e-wallet prompts the user for a spending limit and purchasing restrictions. For example, the e-wallet may be configured to allow twenty dollars to be spent on clothing. Other types of merchandise would not be authorized and clothing purchases over twenty dollars would not be allowed.

The user may also want to register with a trusted third party verification system, such as Verisign™. The e-wallet registers with the trusted third party verification system and receives a digital certificate. The digital certificate may be used when the primary e-wallet purchases merchandise or when the primary e-wallet configures a secondary e-wallet.

Once configured, the e-wallet is ready for purchasing merchandise. The user selects merchandise and takes the merchandise to an electronic checkout system. The electronic checkout system scans the merchandise and calculates a total price of the merchandise. The electronic checkout system sends a message to the e-wallet which includes the total price, the merchandise type, and an authorization request. The e-wallet determines if the transaction is within the e-wallet purchasing restrictions. If the transaction is within the e-wallet purchasing restrictions, the e-wallet prompts the user for a password. The user enters a password and the e-wallet sends the account information to the electronic checkout system. If the e-wallet is registered with a trusted third party verification system, the e-wallet provides the digital certificate during checkout as well. In addition, a public key/private key encryption scheme can be used to digitally sign and encrypt data transmitted between the e-wallet and the merchant.

The e-wallet may also be used to configure other e-wallets at a remote location. For example, a user may have a son at college who has his own e-wallet. The user may want to authorize his son's e-wallet to purchase up to $300 of books for school. The father's e-wallet may communicate with his son's e-wallet through a computer network, such as the Internet, to download the father's account information and purchase restrictions into his son's e-wallet. In this example, the father would restrict the son's e-wallet to spend no more than $300 at a bookstore on school books and supplies. The father's e-wallet may send a digital certificate to ensure his son's e-wallet that the configuration information is valid.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

The present invention may be better understood, and its numerous objects, features, and advantages made apparent to those skilled in the art by referencing the accompanying drawings. The use of the same reference symbols in different drawings indicates similar or identical items.

FIG. 1 is a diagram of a user configuring an e-wallet system;

FIG. 2 is a diagram of an e-wallet system conducting transactions and communicating with a secondary e-wallet;

FIG. 3 is a high level flowchart showing the configuration and usage of an e-wallet;

FIG. 4 is a flowchart showing the activation of one or more e-wallets;

FIG. 5 is a flowchart showing a user configuring an e-wallet;

FIG. 6 is a flowchart showing an e-wallet conducting transactions at a checkout area;

FIG. 7 is a flowchart showing an e-wallet determining whether to authorize a transaction; and

FIG. 8 is a block diagram of an information handling system capable of implementing the present invention.

### DETAILED DESCRIPTION

The following is intended to provide a detailed description of an example of the invention and should not be taken to be limiting of the invention itself. Rather, any number of variations may fall within the scope of the invention which is defined in the claims following the description.

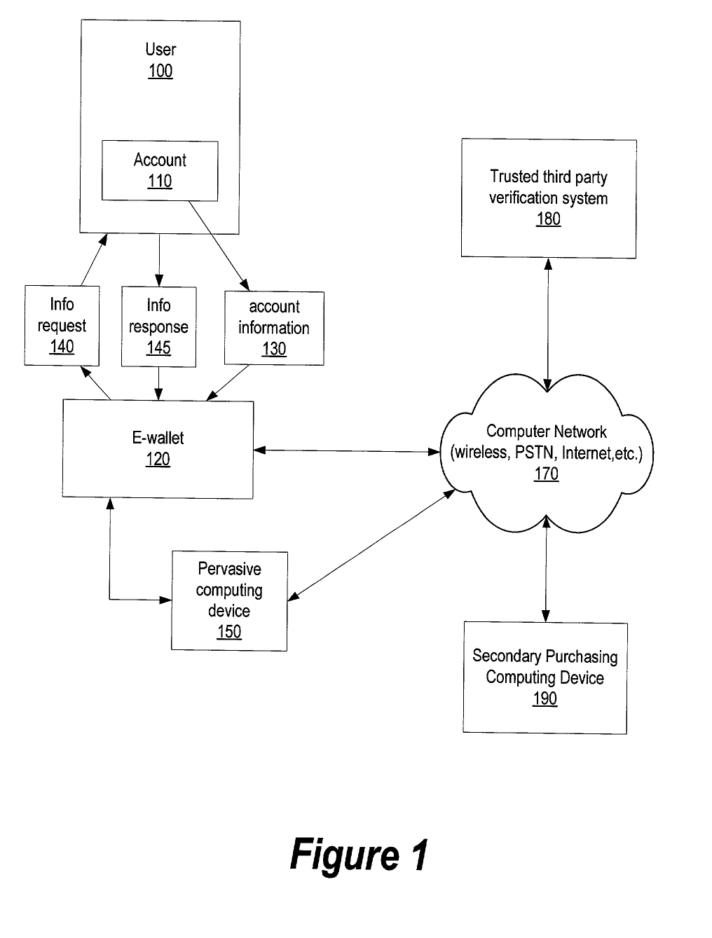

FIG. 1 is a diagram of a user configuring an e-wallet system. User 100 begins a configuration procedure of e-wallet 120 by providing account information 130 to e-wallet 120 that corresponds to user 100's account 110. Account 110 may be a credit card, debit card, or other means that allow financial currency exchange. E-wallet 120 receives account information 130 and prompts user 100 with information request 140. Information request 140 includes requests for a password, a spending limit, and authorized merchandise type. Information request 140 may also include other purchasing restrictions. For example, e-wallet 120 may be configured to allow twenty dollars to be spent on clothing at a specific store. Other types of merchandise are not authorized and clothing purchases over twenty dollars are not allowed.

User 100 responds to information request 140 by sending information response 145 to e-wallet 120. Information response 145 may include responses to information request 140. User 100 may choose to not select a purchasing restriction for one or more request areas. For example, user 100 may want to configure e-wallet 120 to authorize purchases up to twenty dollars, but not limit the type of merchandise that is purchased. In this example, user 100 will not restrict an authorized merchandise type.

User 100 may want to subscribe e-wallet 120 to trusted third party verification system 180 for added security. For example, e-wallet 120 may configure a secondary e-wallet, such as secondary computing device 190, and may want to send a digital certificate during the configuration to validate the identity of the secondary computing device and encrypt confidential data, such as credit card numbers. E-wallet 120 communicates with trusted third party verification system 180 through computer network 170. Computer network 170 may be a wireless network, a PSTN, the Internet, or a combination of various networks. E-wallet 120 registers with trusted third party verification system 180 and receives a digital certificate that ensures merchants that e-wallet 120 is actually e-wallet 120. E-wallet 120 may communicate directly to computer network 170, or through pervasive computing device 150.

Pervasive computing device 150 may be a traditional computerized device, such as a desktop computer, a tower computer, or a portable computer. Pervasive computing device 150 may also be a computerized device such as a personal digital assistant (PDA), a telephone, an appliance, an automobile, or another device. Pervasive computing devices often include a system processor and associated volatile and non-volatile memory, a display area, input means, and often interfaces, such as a network interface or modem, to other computing devices.

User 100 may also want to configure a secondary e-wallet. The secondary e-wallet may be located locally, in which case the configuration procedure may be the same as described above. On the other hand, the secondary e-wallet may be at a remote location, such as with secondary purchasing computing device 190. For example, secondary purchasing device 190 may belong to user 100's son who is attending college in a different geographical area. For example, user 100 may configure secondary purchasing device 190 to authorize purchases for books up to $300.

User 100 configures secondary purchasing computing device 190 using e-wallet 120. E-wallet 120 sends configuration information to secondary purchasing computing device 190 through computer network 170. Configuration information may be encrypted and include purchasing restriction information, account information, and a digital certificate. E-wallet 120 may communicate directly with computer network 170, or through pervasive computing device 150.

Secondary purchasing computing device 190 may include multiple financial accounts. For example, secondary purchasing device 190 may include an account to purchase books as described above, and may also include an account that charges purchases other than books to the son's credit card. If secondary purchasing computing device 190 detects that a purchase is a book purchase, the merchandise is charged to user 100's account. Otherwise, transactions are charged to the son's account.

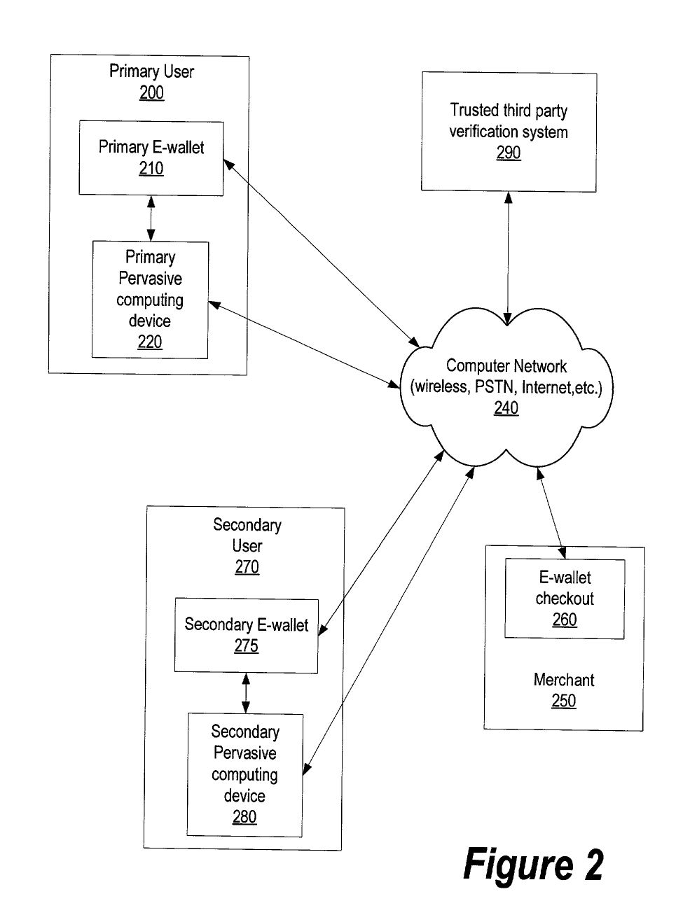

FIG. 2 is a diagram of an e-wallet system conducting transactions and communicating with a secondary w-wallet. Primary user 200 uses primary e-wallet 210 to purchase merchandise at merchant 250. Primary user 200 selects which merchandise to purchase, and provides it to e-wallet checkout 260 that is accessible by merchant 250. E-wallet checkout 260 scans the merchandise and calculates the total cost of the merchandise. E-wallet checkout 260 sends an authorization request to primary e-wallet 210 through computer network 240. The authorization request includes a total cost of the merchandise, a type of merchandise being purchased, and a request for account information. Computer network 240 may communicate directly to primary e-wallet 210, or through primary pervasive computing device 220.

Primary e-wallet 210 receives the authorization request from e-wallet checkout 260, and verifies that the transaction is within the purchasing restrictions of the primary e-wallet account. If the transaction is within the purchasing restrictions of the primary e-wallet account, primary e-wallet prompts primary user 200 for a password. Primary user 200 enters a password, and primary e-wallet 210 sends account information to e-wallet checkout 260 through computer network 240. E-wallet checkout 260 receives the account information, and may decide to verify the authorization with trusted third party verification system 290. E-wallet checkout 260 communicates with trusted third party verification system 290 through computer network 240. Once e-wallet checkout 260 receives verification from trusted third party verification system 290, e-wallet checkout 260 executes the purchase transaction.

Secondary user 270 may use secondary e-wallet 275 to purchase merchandise at merchant 250. The way in which secondary user 270 uses secondary e-wallet 275 and secondary pervasive computing device 280 to purchase merchandise corresponds to how primary user 200 uses primary e-wallet 210 and primary pervasive computing device 220 to purchase merchandise.

Secondary e-wallet 275 may include one or more financial accounts. For example, a college students' e-wallet may have a financial account configured by his fathers' e-wallet to purchase books. The college students' e-wallet may also include a financial account configured by his grandparent's e-wallet to purchase food. The college students e-wallet may have yet another account to charge transactions to his credit card that are not covered by the other two accounts described above.

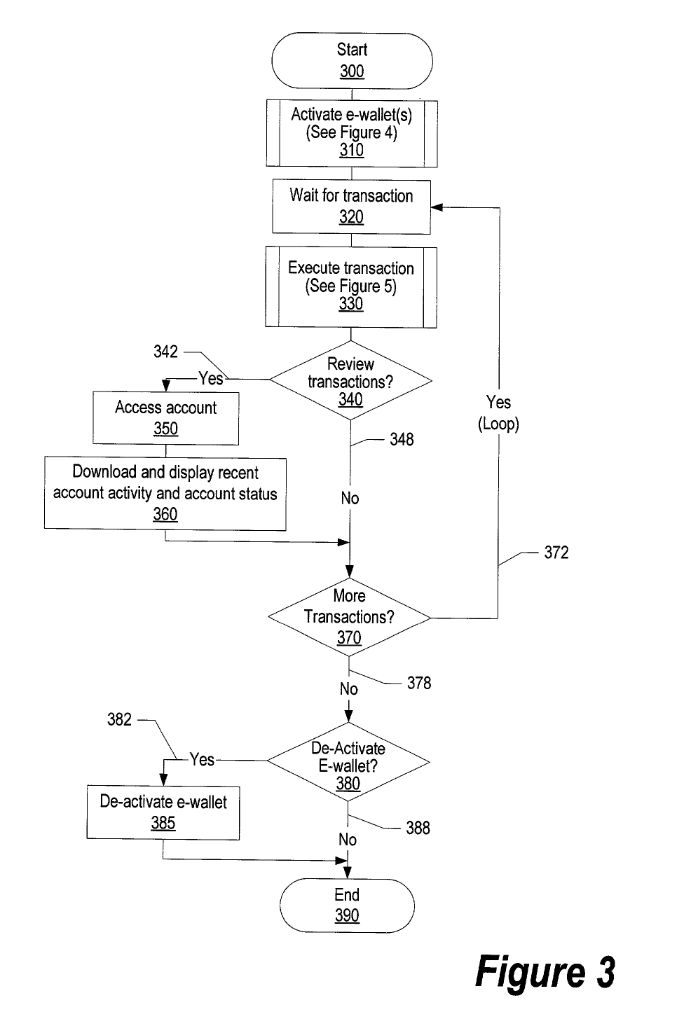

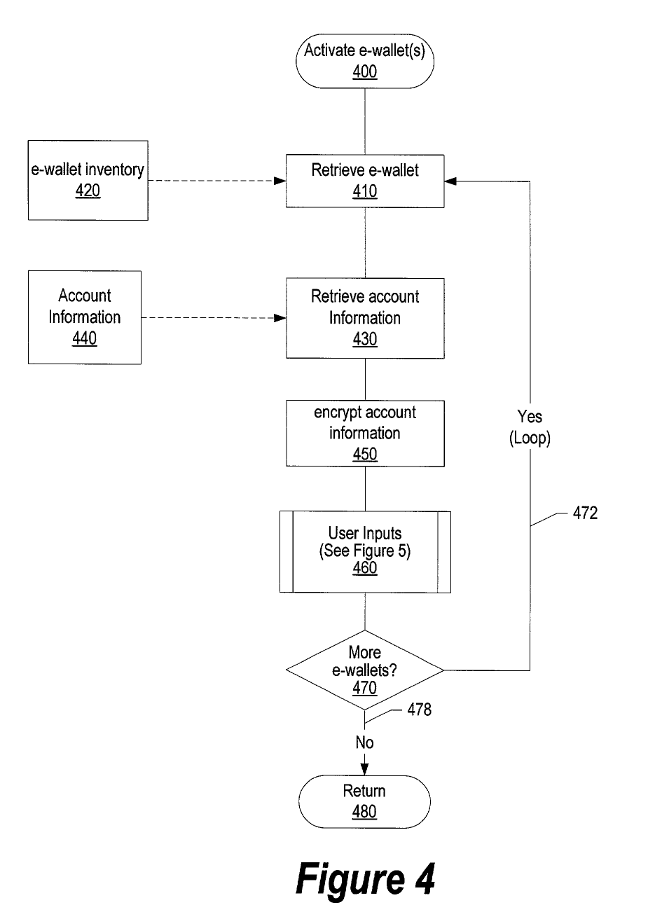

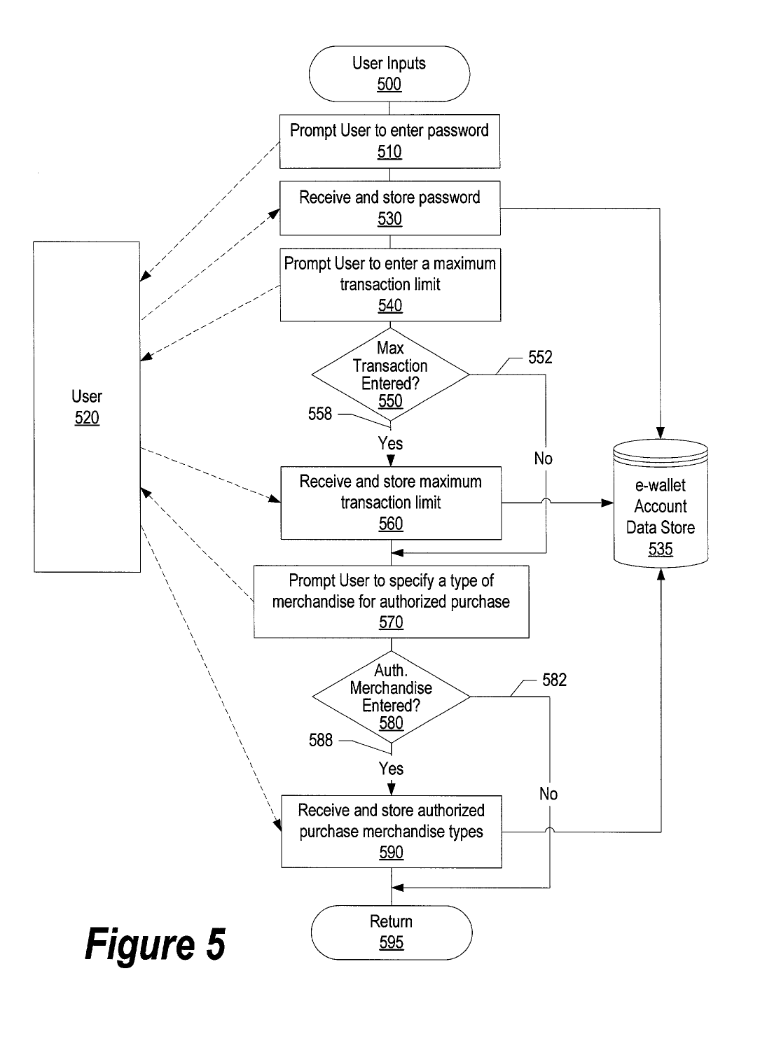

FIG. 3 is a high level flowchart showing the configuration and usage of an e-wallet. Processing commences at 300, whereupon an e-wallet is activated (pre-defined process block 310, see FIG. 4 for further details). Once the e-wallet is activated, the e-wallet waits for a transaction (step 320). For example, if a user uses an e-wallet in a shopping mall, the e-wallet waits until the user buys merchandise. The e-wallet receives a signal from a checkout system asking for information and the e-wallet executes the transaction (pre-defined process block 380, see FIG. 5 for further details).

A determination is made as to whether the user wants to review account history (decision 340). For example, the user may want to access his account to see how much credit he has left to make purchases. Another example is that the user may have activated a second e-wallet for his daughter who is also shopping in the shopping mall. The user may want to access her e-wallet directly to review what she has purchased. If the user wants to review previous transactions, decision 340 branches to “Yes” branch 342 whereupon the users' account is accessed (step 350). For example, the users' e-wallet may communicate with the checkout system and have the checkout system access his account over a computer network. Once the account is accessed, recent charges and available credit are downloaded to the e-wallet and displayed for the user to review (step 360). If the user chooses not to review account history, decision 340 braches to “No” branch 348 bypassing the account review steps.

A decision is made as to whether the user is executing more transactions (decision 370). If the user is executing more transactions, decision 370 branches to “Yes” branch 372 which loops back and waits for more transactions at step 320. This looping continues until there are no more transactions, at which point decision 370 branches to “No” branch 378. A determination is made as to whether to de-activate the e-wallet (step 380). For example, if the user rents an e-wallet that belongs to a shopping mall, the e-wallet is de-activated once the user is finished shopping. If the e-wallet will be de-activated, decision 380 branches to “Yes” branch 382 whereupon the e-wallet is de-activated at step 385. On the other hand, if the e-wallet will not be de-activated, decision 380 branches to “No” branch 388 whereupon processing ends at 390.

FIG. 4 is a flowchart showing the activation of one or more e-wallets. Processing commences at 400, whereupon an e-wallet is retrieved from e-wallet inventory 420 (step 410). For example, a user may own an e-wallet in which case the user may retrieve the e-wallet from his kitchen table. In another example, the user may rent an e-wallet from a shopping mall in which case the user may retrieve an e-wallet from an e-wallet rental area within the shopping mall.

Account information is retrieved from user 440 at step 430. For example, the user may swipe a credit card on the e-wallet to input the users' credit card information. The user may also swipe a debit card, or other means that allows currency transactions. The account information may also be downloaded from a pervasive computing device. The account information is encrypted at step 450 for security purposes. User inputs are processed (pre-defined process block 460, see FIG. 5 for further details), and a determination is made as to activate more e-wallets (decision 470). If more e-wallets are activated, decision 470 branches to “Yes” branch 472 which loops back and retrieves another e-wallet at step 410. This looping continues until the user chooses not to activate more e-wallets, at which point decision 470 branches to “No” branch 478 whereupon processing returns at 480.

FIG. 5 is a flowchart showing a user configuring an e-wallet. Processing commences at 500, whereupon processing prompts user 520 to enter a password (step 510). Processing receives the password from user 520 and stores it in e-wallet account data store 535 (step 530). For example, e-wallet account data store may be a non-volatile storage area located within the e-wallet. Processing prompts user 520 to enter a maximum transaction limit at step 540. A determination is made as to whether the user enters a maximum transaction limit (decision 550). For example, the user may not want to limit himself to spend a certain amount, in which case the user may not enter a maximum spending limit. If the user enters a maximum spending limit, decision 550 branches to “Yes” branch 558 whereupon processing receives the maximum spending limit from user 520 and stores it in information store 535 (step 560). On the other hand, if the user does not enter a maximum spending limit, decision 550 branches to “No” branch 552 bypassing spending limit processing. User 520 is prompted to specify an authorized merchandise type. For example, if a user configures an e-wallet for his daughter to use at a shopping mall, the user may allow his daughter to purchase school supplies and may not allow other merchandise to be purchased.

A determination is made as to whether the user enters an authorized merchandise type (decision 580). If user 520 enters an authorized merchandise type, decision 580 branches to “Yes” branch 588 whereupon processing retrieves the authorized merchandise type from user 520 and stores it in information store 535 (step 590). On the other hand, if user 520 does not enter an authorized merchandise type, decision 580 branches to “No” branch 582 bypassing purchase type processing. Processing returns at 595.

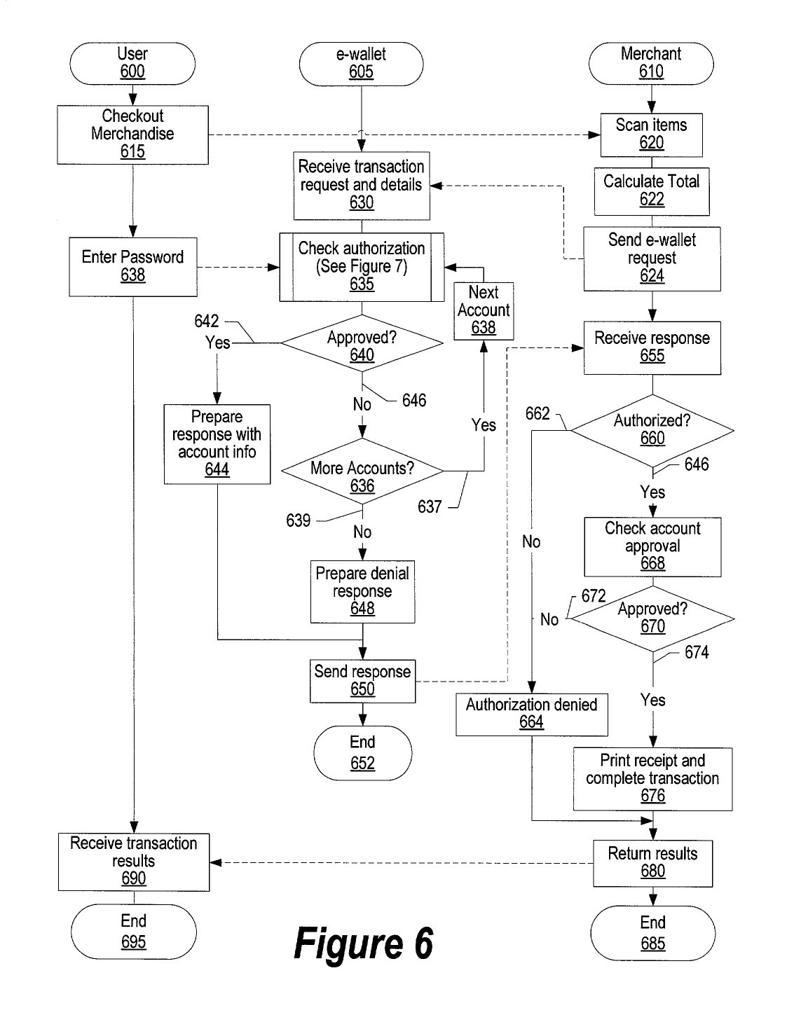

FIG. 6 is a flowchart showing an e-wallet conducting a transaction at a merchant's checkout area. User processing commences at 600, whereupon a user selects merchandise to purchase (step 615). Merchant processing commences at 610, whereupon the merchant's electronic checkout system scans the merchandise (step 620). For example, the checkout system may have a bar code reader that scans a bar code on the merchandise, which includes information about the merchandise. The checkout system calculates the total price of the scanned merchandise at step 622, and sends a request to the user's e-wallet (step 624).

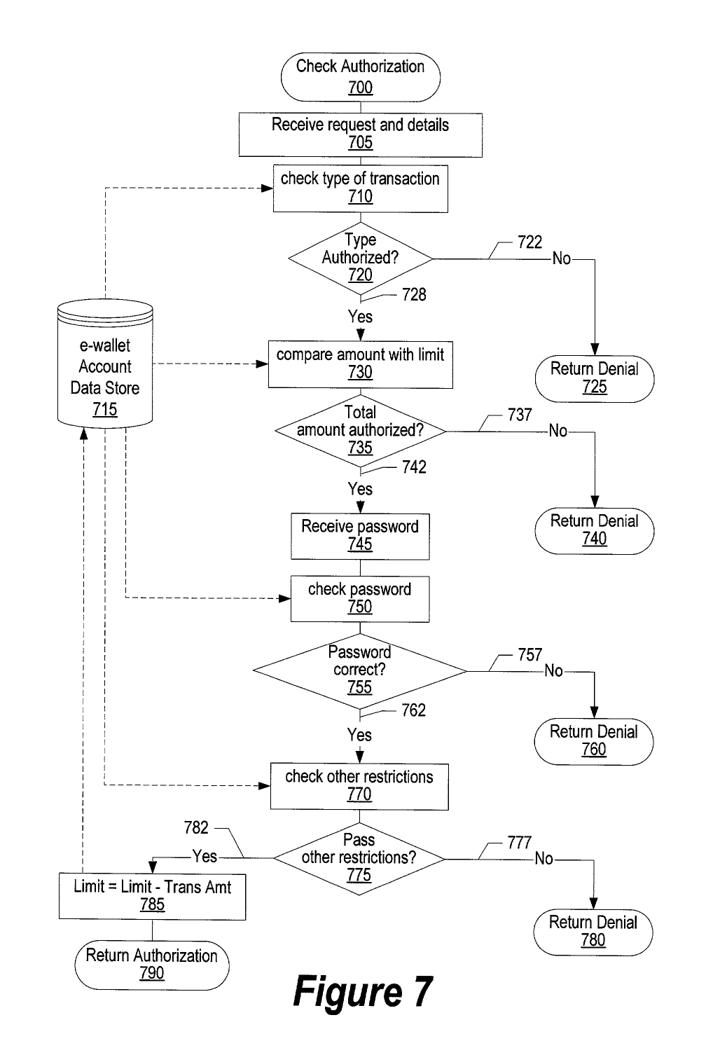

E-wallet processing commences at 605, whereupon the e-wallet receives the merchant's request which includes the total price of the merchandise, the type of merchandise, and an authorization request (step 630). The authorization request is processed (pre-defined process block 635, see FIG. 7 for further details). During the authorization request, the user is prompted by the e-wallet to enter a password (step 638). A determination is made as to whether the authorization is approved (decision 640). If the authorization is approved, decision 640 branches to “Yes” branch 642 whereupon a response is prepared which includes the appropriate account information to purchase the merchandise (step 644). On the other hand, if the authorization is not approved, decision 640 branches to “No” branch 646 whereupon a determination is made as to whether the e-wallet has more accounts that may authorize the transaction. For example, a college student's e-wallet may include an account configured by his parents to purchase school books, and another account to charge transactions to the student's credit card for transactions other than school books. If there are more accounts to check, decision 636 branches to “Yes” branch 637 which loops back and retrieves the next account (step 638) to check authorization. This looping continues until there are no more accounts to check, at which point decision 636 branches to “No” branch 639. An authorization denial message is prepared at step 648. The prepared response is sent to the merchant (step 650), and e-wallet processing ends at 652.

The merchant receives the e-wallet response at step 655, and a determination is made as to whether the authorization request is authorized (decision 660). If the authorization request is not authorized, decision 660 branches to “No” branch 662 whereupon the merchant denies the transaction request (step 664) and may request an alternate method of payment. For example, the user may have cash or another e-wallet to pay for the merchandise. On the other hand, if the authorization request is authorized by the e-wallet, decision 660 branches to “Yes” branch 646 whereupon the merchant checks the account information for approval that was sent by the e-wallet. For example, if the e-wallet sends a credit card number, the merchant may contact the credit card company to verify the number is valid and that the account has enough credit available to pay for the merchandise.

A determination is made as to whether the account is approved (decision 670). If the account is not approved, decision 670 branches to “No” branch 672 whereupon the merchant denies the transaction request (step 664) and may request an alternate method of payment. On the other hand, if the account is approved, decision 670 branches to “Yes” branch 674 whereupon the merchant completes the transaction and prints out a receipt (step 676). The transaction results are returned to the user at step 680, whereupon merchant processing ends at 685. The user receives the transaction results (step 690), whereupon user processing ends at 695.

FIG. 7 is a flowchart showing an e-wallet determining whether to authorize a transaction. Processing commences at 700, whereupon the e-wallet receives transaction details and an authorization request from an electronic checkout system (step 705). Processing retrieves transaction type restrictions from e-wallet account data store 715 and compares them with the transaction type being processed (step 710). A determination is made as to whether the transaction type is authorized (decision 720). For example, the e-wallet may allow clothing transaction types, but not allow other types of merchandise to be purchased. If the transaction type is not authorized, decision 720 branches to “No” branch 722 whereupon processing returns a denial of authorization at 725. On the other hand, if the type of transaction is authorized, decision 720 branches to “Yes” branch 728 whereupon processing retrieves a purchasing limit restriction from e-wallet account data store 715 and compares it with the transaction amount being processed (step 730). The original purchasing limit restriction may be decreased due to previous purchases. For example, the user may have configured an original purchasing limit restriction of $100. If the user has made $20 of previous purchases, the new purchasing limit restriction is $80.

A determination is made as to whether the amount being processed is within the purchasing limit restriction (decision 735). If the amount being reviewed is over the purchasing limit restriction, decision 735 branches to “No” branch 737 whereupon processing returns a denial of authorization at 740. On the other hand, if the amount being processed is within the purchasing limit restriction, decision 735 branches to “Yes” branch 742 whereupon a password is received from the user (see step 638 on FIG. 6). Processing retrieves the correct password from e-wallet account data store 715 and compares it with the password that the user enters (step 750).

A determination is made as to whether the user enters the correct password (decision 755). If the user did not enter the correct password, decision 755 branches to “No” branch 757 whereupon processing returns a denial of authorization at 760. In another embodiment, the e-wallet may be configured to allow a user to attempt to enter the correct password a certain number of times before returning a denial of authorization. On the other hand, if the user enters the correct password, decision 755 branches to “Yes” branch 762 whereupon other restrictions are checked with purchasing restrictions stored in e-wallet account data store 715. For example, the e-wallet may be configured to restrict the purchase of merchandise on a certain day, such as Monday.

A determination is made as to whether the transaction request is within the other purchasing restrictions (decision 775). For example, if a user is on vacation, the user may configure a restriction to authorize purchases in the city he is visiting, but not in other cities. Another example is that the user may want to budget his spending and allow the e-wallet to authorize transactions during a weekday, but not on a weekend. If the transaction details are not within the other purchasing restrictions, decision 775 branches to “No” branch 777 whereupon processing returns a denial of authorization at 780. On the other hand, if the transaction details are within the other purchasing restrictions, decision 775 branches to “Yes” branch 782 whereupon the e-wallet limit, if applicable, is reduced by the amount of the transaction (step 785), and processing returns an authorization to complete the transaction at 790.

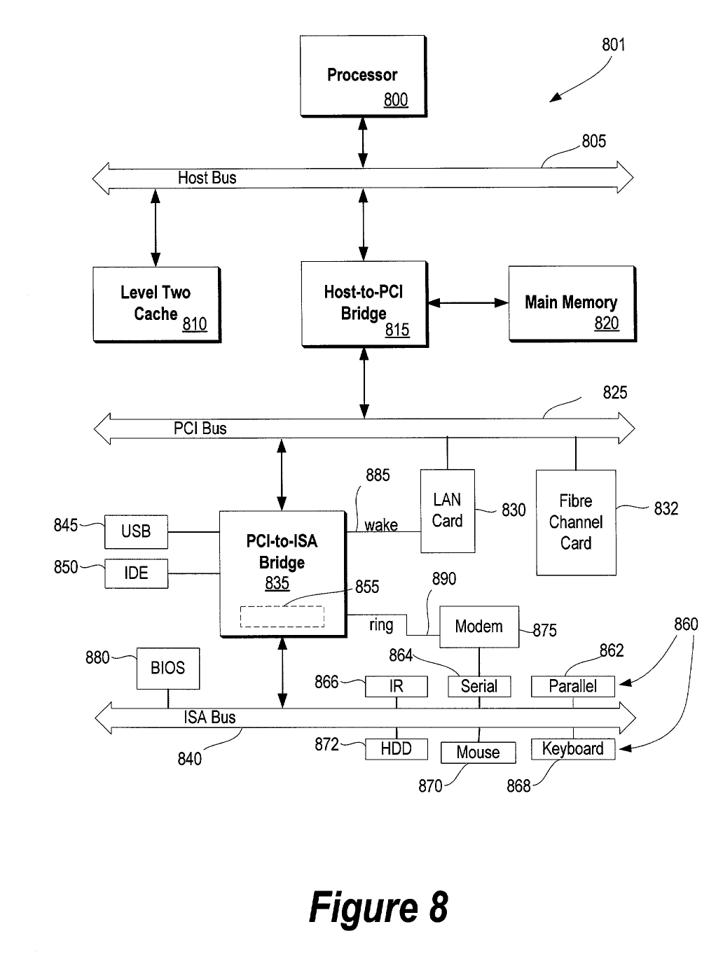

FIG. 8 illustrates information handling system 801 which is a simplified example of a computer system capable of performing the server and client operations described herein. Computer system 801 includes processor 800 which is coupled to host bus 805. A level two (L2) cache memory 810 is also coupled to the host bus 805. Host-to-PCI bridge 815 is coupled to main memory 820, includes cache memory and main memory control functions, and provides bus control to handle transfers among PCI bus 825, processor 800, L2 cache 810, main memory 820, and host bus 805. PCI bus 825 provides an interface for a variety of devices including, for example, LAN card 830. PCI-to-ISA bridge 835 provides bus control to handle transfers between PCI bus 825 and ISA bus 840, universal serial bus (USB) functionality 845, IDE device functionality 850, power management functionality 855, and can include other functional elements not shown, such as a real-time clock (RTC), DMA control, interrupt support, and system management bus support. Peripheral devices and input/output (I/O) devices can be attached to various interfaces 860 (e.g., parallel interface 862, serial interface 864, infrared (IR) interface 866, keyboard interface 868, mouse interface 870, and fixed disk (HDD) 872) coupled to ISA bus 840. Alternatively, many I/O devices can be accommodated by a super I/O controller (not shown) attached to ISA bus 840.

BIOS 880 is coupled to ISA bus 840, and incorporates the necessary processor executable code for a variety of low-level system functions and system boot functions. BIOS 880 can be stored in any computer readable medium, including magnetic storage media, optical storage media, flash memory, random access memory, read only memory, and communications media conveying signals encoding the instructions (e.g., signals from a network). In order to attach computer system 801 to another computer system to copy files over a network, LAN card 830 is coupled to PCI bus 825 and to PCI-to-ISA bridge 835. Similarly, to connect computer system 801 to an ISP to connect to the Internet using a telephone line connection, modem 875 is connected to serial port 864 and PCI-to-ISA Bridge 835.

While the computer system described in FIG. 8 is capable of executing the invention described herein, this computer system is simply one example of a computer system. Those skilled in the art will appreciate that many other computer system designs are capable of performing the invention described herein.

One of the preferred implementations of the invention is an application, namely, a set of instructions (program code) in a code module which may, for example, be resident in the random access memory of the computer. Until required by the computer, the set of instructions may be stored in another computer memory, for example, on a hard disk drive, or in removable storage such as an optical disk (for eventual use in a CD ROM) or floppy disk (for eventual use in a floppy disk drive), or downloaded via the Internet or other computer network. Thus, the present invention may be implemented as a computer program product for use in a computer. In addition, although the various methods described are conveniently implemented in a general purpose computer selectively activated or reconfigured by software, one of ordinary skill in the art would also recognize that such methods may be carried out in hardware, in firmware, or in more specialized apparatus constructed to perform the required method steps.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For a non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

What is claimed is:

1. A method of electronic transaction processing, said method comprising:
receiving a secondary account request from a primary account holder;
authenticating the primary account holder using a primary authentication key; and
configuring a second account based on the secondary account request in response to the authenticating.

2. The method as described in claim 1 wherein the configuring further includes:
setting one or more purchasing restrictions.

3. The method as described in claim 2 wherein the purchasing restrictions are selected from the group consisting of a secondary authentication key, a secondary spending limit, and a secondary authorized merchandise type.

4. The method as described in claim 2 further comprising:
receiving a purchase request corresponding to the secondary account;
comparing the purchasing restrictions with the purchase request; and
authorizing the purchase request in response to the comparing.

5. The method as described in claim 1 further comprising:
sending a secondary purchase history corresponding to the second account to the primary account holder; and
displaying the secondary purchase history on a pervasive computing device corresponding to the primary account holder.

6. The method as described in claim 1 further comprising:
receiving a purchase request from a secondary account holder that corresponds to the second account;
verifying a sufficient account balance corresponding to a primary account that corresponds to the primary account holder;
comparing one or more purchasing restrictions applied to the second account with the purchase request; and
authorizing the purchase request based on the verifying and the comparing.

7. The method as described in claim 6 wherein the authorizing further includes:
receiving a digital signature corresponding to the purchase request; and
determining whether the digital signature is authentic.

8. The method as described in claim 1 further comprising:
assigning a plurality of financial accounts to the second account;
setting one or more purchase restrictions for one or more financial accounts;
receiving a purchase request from a secondary account holder that corresponds to the second account;
determining whether the purchase request satisfies each of the purchase restrictions that corresponds to a first financial account from the plurality of financial accounts; and
comparing the purchase request to a second financial account from the plurality of financial accounts based on the determination.

9. An information handling system comprising:
one or more processors;
a memory accessible by the processors;
one or more nonvolatile storage devices accessible by the processors;
an electronic transaction tool to execute transactions, the electronic transaction tool including:
means for receiving a secondary account request from a primary account holder;
means for authenticating the primary account holder using a primary authentication key; and
means for configuring a second account based on the secondary account request in response to the authenticating.

10. The information handling system as described in claim 9 wherein the means for configuring further includes:
means for setting one or more purchasing restrictions.

11. The information handling system as described in claim 10 wherein the purchasing restrictions are selected from the group consisting of a secondary authentication key, a secondary spending limit, and a secondary authorized merchandise type.

12. The information handling system as described in claim 10 further comprising:
means for receiving a purchase request corresponding to the secondary account;
means for comparing the purchasing restrictions with the purchase request; and
means for authorizing the purchase request in response to the comparing.

13. The information handling system as described in claim 9 further comprising:
means for sending a secondary purchase history corresponding to the second account to the primary account holder; and
means for displaying the secondary purchase history on a pervasive computing device corresponding to the primary account holder.

14. The information handling system as described in claim 9 further comprising:
means for receiving a purchase request from a secondary account holder that corresponds to the second account;
means for verifying a sufficient account balance corresponding to a primary account that corresponds to the primary account holder;
means for comparing one or more purchasing restrictions applied to the second account with the purchase request; and
means for authorizing the purchase request based on the verifying and the comparing.

15. The information handling system as described in claim 14 wherein the means for authorizing further includes:
means for receiving a digital signature corresponding to the purchase request; and
means for determining whether the digital signature is authentic.

16. The information handling system as described in claim 9 further comprising:
means for assigning a plurality of financial accounts to the second account;
means for setting one or more purchase restrictions for one or more financial accounts;
means for receiving a purchase request from a secondary account holder that corresponds to the second account;
means for determining whether the purchase request satisfies each of the purchase restrictions that corresponds to a first financial account from the plurality of financial accounts; and
means for comparing the purchase request to a second financial account from the plurality of financial accounts based on the determination.

17. A computer program product stored in a computer operable media for executing electronic transactions, said computer program product comprising:
means for receiving a secondary account request from a primary account holder;
means for authenticating the primary account holder using a primary authentication key; and
means for configuring a second account based on the secondary account request in response to the authenticating.

18. The computer program product as described in claim 17 wherein the means for configuring further includes:
means for setting one or more purchasing restrictions.

19. The computer program product as described in claim 18 wherein the purchasing restrictions are selected from the group consisting of a secondary authentication key, a secondary spending limit, and a secondary authorized merchandise type.

20. The computer program product as described in claim 18 further comprising:
means for receiving a purchase request corresponding to the secondary account;
means for comparing the purchasing restrictions with the purchase request; and
means for authorizing the purchase request in response to the comparing.

21. The computer program product as described in claim 17 further comprising:
means for sending a secondary purchase history corresponding to the second account to the primary account holder; and
means for displaying the secondary purchase history on a pervasive computing device corresponding to the primary account holder.

22. The computer program product as described in claim 17 further comprising:
means for receiving a purchase request from a secondary account holder that corresponds to the second account;
means for verifying a sufficient account balance corresponding to a primary account that corresponds to the primary account holder;
means for comparing one or more purchasing restrictions applied to the second account with the purchase request; and
means for authorizing the purchase request based on the verifying and the comparing.

23. The computer program product as described in claim 22 wherein the means for authorizing further includes:
means for receiving a digital signature corresponding to the purchase request; and
means for determining whether the digital signature is authentic.

24. The computer program product as described in claim 17 further comprising:
means for assigning a plurality of financial accounts to the second account;
means for setting one or more purchase restrictions for one or more financial accounts;
means for receiving a purchase request from a secondary account holder that corresponds to the second account;
means for determining whether the purchase request satisfies each of the purchase restrictions that corresponds to a first financial account from the plurality of financial accounts; and
means for comparing the purchase request to a second financial account from the plurality of financial accounts based on the determination.
